(19) United States
(12) Patent Application Publication
(10) Pub. No.: US 2023/0089607 A1
(43) Pub. Date: Mar. 23, 2023

(54) MIXING MACHINE

(71) Applicant: Dane Turk, Columbus, OH (US)

(72) Inventor: Dane Turk, Columbus, OH (US)

(21) Appl. No.: 17/933,398

(22) Filed: Sep. 19, 2022

Related U.S. Application Data
(60) Provisional application No. 63/245,239, filed on Sep. 17, 2021.

(51) Int. Cl. A47J 43/046; A47J 19/00; A23C 11/10; A47J 43/07

(52) U.S. Cl. CPC A47J 43/046; A47J 19/00; A23C 11/103; A47J 43/0722

(57) ABSTRACT

This present invention relates to a nut blender for making nut milk. The blender comprises a mixer including a cap, a blender body, a mixing blade configuration, and a heating element for blending nuts. A plurality of mixer controls including a variety of preselectable settings for simultaneous blend duration setting and temperature setting. The plurality of mixer controls include at least three settings, wherein a first setting includes a first blend duration and a first heat setting, a second setting includes a second blend duration and a second heat setting, and a third setting includes a third blend duration and a third heat setting. The second heat setting can be greater than the first heat setting, and the third heat setting can be greater than the second heat setting.

### CROSS-REFERENCE TO RELATED APPLICATION

The present application claims priority to, and the benefit of, U.S. Provisional Application No. 63/245,239, which was filed on Sep. 17, 2021, and is incorporated herein by reference in its entirety.

### FIELD OF THE INVENTION

The present invention relates generally to the field of mixing machines and blenders. More specifically, the present invention relates to an improved mixing machine with particular settings and mixing functions for making different varieties of nut milk and different concoctions using nut milk. The mixing machine includes combinations of temperature settings, blending speeds, filters, and/or blending durations to enable a variety of different nut milk blends and nut milk concoctions. The improved mixing machine enables predeterminable settings to achieve the desired blended varieties. Additionally, the improved mixing machine enables the users to predetermine a particular nut milk blend for a preselectable combination of blend duration and temperature setting. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, various kinds of mixers and blenders are used by individuals to mix and blend ingredients (i.e. liquids, solids, and semi-solids) to create edible mixtures and concoctions for consumption. Conventional mixers combine a speed setting (i.e. mixing blade speed) and a function setting to enable a user to achieve a desired blending result. Temperature of the mixed ingredients is typically serendipitously established by reaching an ‘equilibrium’ temperature based on the volume and temperature of the respective ingredients placed into a blender container and mixed therein. Thus, typical blenders cannot establish a desired or predeterminable temperature of the final blended composition with a programmed setting; but rather, the ingredients default to an ‘equilibrium’ temperature that is reached based on the temperature and volume of the respective individual ingredients.

Various solutions are available in the state of the art to allow users to blend or mix ingredients. For example, some blenders provide mixing capabilities for large quantities, while other blenders can include a volume suited for single servings. However, heretofore known blenders are not suited for single serving preparations of nut milk that is extracted from nuts and blended to a predeterminable temperature and consistency. An efficient, programmable, and portable mixer is therefore desired by the users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a blender or mixing machine including a selectable speed, a temperature setting, and/or a duration setting to reach desired temperature and blending consistency. In one potential embodiment, the mixing machine includes distinct temperature settings of no heat, warm heat, and hot heat. As a part of the blending and heating cycles, the mixing machine can run, mix, or blend for predefined periods to reach a selectable desired temperature (i.e. minimum temperature) and blending setpoints. The selectable heat and blending settings enable particular varieties of nut milk and particular concoctions to be blended.

In one potential embodiment, the mixing machine comprises a blender configured for a single serving nut milk variety mixture. Exemplary volumes include ranges from about 4 ounces to about 24 ounces per cycle of the mixing machine. The exemplary volumes, and others therebetween, can be enabled with interior marked fill lines (i.e. min and max fill lines) in an interior of a mixing container or blender body. The serving volume of the unit can be modified based on the preference of the user.

In one potential embodiment, the mixer or nut blender for making nut milk comprises: a mixer including a cap or lid, a blender body, a mixing blade configuration, a filter(s), and a heating element for blending nuts and heating ingredients within the blender body; and, a plurality of mixer controls including a variety of preselectable settings for simultaneous blend duration and temperature setting. The plurality of mixer controls include at least three settings: wherein a first setting includes a first blend duration and a first heat setting; a second setting includes a second blend duration and a second heat setting; and, a third setting includes a third blend duration and a third heat setting. The second heat setting can be greater than the first heat setting, and the third heat setting can be greater than the second heat setting.

In other embodiments, the second blend duration can be greater than the first blend duration, and the third blend duration can be greater than the second blend duration. The first heat setting can be zero and the first blend duration can be less than or equal to 2 minutes. The second heat setting can be less than or equal to 70 degrees C. and the second blend duration can be less than or equal to 6 minutes. The third heat setting can be less than or equal to 120 degrees C. and the third blend duration can be less than or equal to 20 minutes.

In still further embodiments, the nut blender comprises a single serving quantity from about 4 ounces to about 24 ounces. A removable internal filter can be integrated with the blender body for filtering nut pulp from the nut milk. The filter can be situated between the cap and the blender body. The filter, in one embodiment, includes a mesh size from about 50 microns to about 250 microns. The filter, in another embodiment, includes a mesh size from about 50 microns to about 1000 microns.

Still further, the mixing machine can include a selectively removable filtration device for minimizing the amount of pulp in the consumable product or final mixture. The mixing machine can include an external and/or an internal filtration unit, or perforated device, selectively actuated by the user as desired for optimal pulp removal or straining in the final product or mixture. The filtration unit can comprise a specific wire mesh size, or perforation size, in order to allow the milk to pass or strain therethrough, while capturing nut pulp, dried fruit pieces, and other particulates from the blended concoction.

The mixing machine can further include a blender body comprising a stainless steel interior and a plastic or polymer exterior. An electric power unit powers a motor for turning the blender blades. The motor also powers a heating element for selective heat settings to heat the ingredients placed and blended within the blender body. The electric power unit can include an electric cord and plug for connecting to an electric source or circuit including, for example, a 110V/60 HZ input or 220V-240V/50 HZ input power. The mixing machine further includes a cover for protecting the electronics therein.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a nut milk blender device of the present invention in accordance with the disclosed architecture;

FIG. 2 illustrates an electric schematic diagram of the nut milk blender device;

FIG. 3 illustrates a perspective view of the components comprising the nut milk blender;

FIG. 4 illustrates an enlarged top plan view of a mixing blade arrangement in one potential embodiment of the invention in accordance with the disclosed architecture;

FIG. 5 illustrates an enlarged perspective view of the interior of a lid for the nut milk blender in one potential embodiment of the invention in accordance with the disclosed architecture;

FIG. 6 illustrates an enlarged cross section view of a lid/cap and filter for the nut milk blender in another embodiment of the invention in accordance with the disclosed architecture;

FIG. 7 illustrates a perspective view of the lid/cap and filter combination of FIG. 6 in accordance with the disclosed architecture; and

FIG. 8 illustrates a top view of the lid/cap and filter inserted into the nut blender device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long felt need in the art for a nut milk blender that can selectively provide for a variety of distinct blend durations and heat settings. As part of the blending and heating cycles, the blender can mix for defined periods of time and can reach desired temperatures (i.e. minimum temperatures) for predeterminable blending setpoints. The nut milk blender can include single serving quantities with an internal volume from about 4 ounces to about 24 ounces. The single serving quantities, along with an integrated filter and/or straining pour spout, minimizes the amount of nut pulp that ends up in the final drinkable blended milk product or blended concoction.

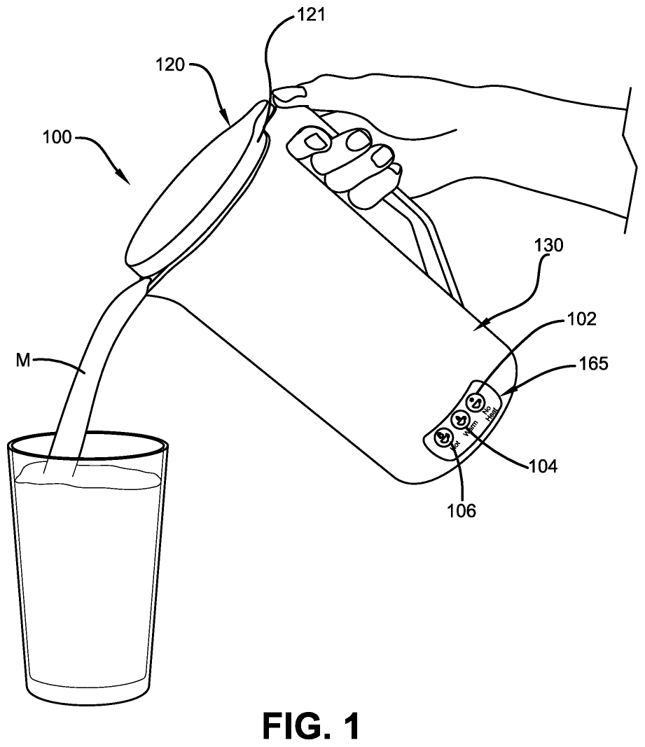

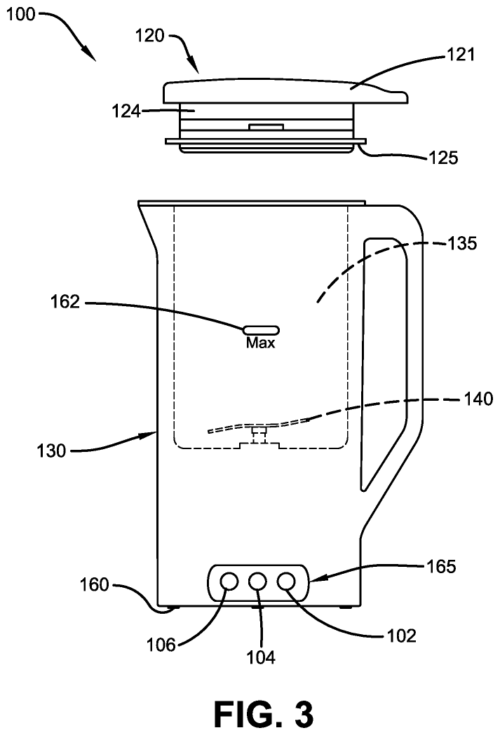

Referring initially to the drawings, FIGS. 1 and 3 illustrate perspective views of one potential embodiment of a nut milk blender device of the present invention in accordance with the disclosed architecture. The nut milk blender 100 of the present invention is a blender or mixing machine including selectable functions having speed settings, temperature settings, and/or duration settings to reach desired temperature and blending consistency. In one potential embodiment, the mixing machine 100 includes distinct temperature settings of no heat 102, warm heat 104, and hot heat 106. As a part of the blending and heating cycles, the mixing machine 100 can run, mix, or blend for predefined periods or durations to reach a selectable desired temperature and blending setpoints. The selectable heat and blending settings 102, 104, 106 enable particular varieties of nut milk to be blended and particular consistency of the resultant concoctions.

In one potential embodiment, the mixing machine 100 comprises a blender configured for a single serving nut milk variety mixture. Exemplary volumes include ranges from about 4 ounces to about 24 ounces per cycle of the mixing machine 100. The exemplary volumes, and others therebetween, can be marked with fill lines 162 (i.e. specific volume markings) in an interior and/or exterior of a mixing container (FIG. 3). The serving volume of the mixing machine 100 unit can be modified based on the preference of the user.

In one potential embodiment, a mixing or nut blender 100 for making nut milk M comprises: a mixer including a cap/lid 120, a blender body 130, a mixing blade configuration 140, an internal cup body 135, a heating element 160 for blending nuts, and a plurality of mixer controls 165 including a variety of preselectable settings 102, 104, 106 for simultaneous blend duration and temperature setting. The plurality of mixer controls 102, 104, 106 include at least three settings, wherein a first setting 102 includes a first blend duration and a first heat setting; a second setting 104 includes a second blend duration and a second heat setting; and, a third setting 106 includes a third blend duration and a third heat setting. The second heat setting 104 can be higher than the first heat setting 102; and, the third heat setting 106 can be higher than the second heat setting 104. Pressing one of the controls 102, 104, 106 twice in quick succession can terminate the setting currently in progress.

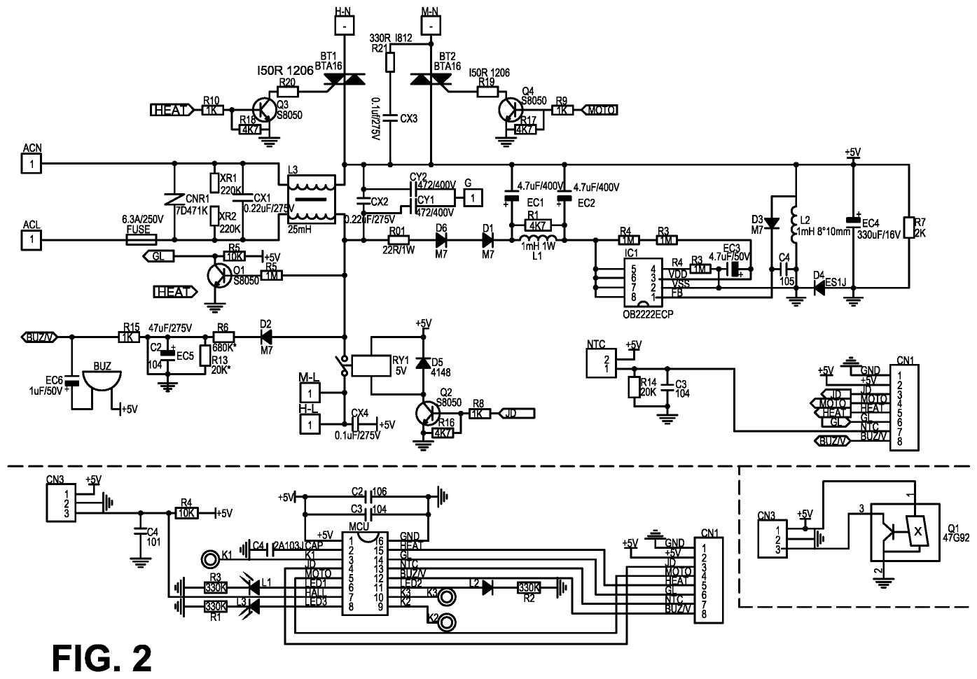

In other embodiments, the second blend duration is greater (i.e. longer) than the first blend duration, and the third blend duration is greater or longer than the second blend duration. The first heat setting 102 can be zero and the first blend duration can be less than or equal to 2 minutes. The second heat setting 104 can be less than or equal to 70 degrees C. and the second blend duration can be less than or equal to 6 minutes. The third heat setting 106 can be less than or equal to 120 degrees C. and the third blend duration can be less than or equal to 20 minutes. FIG. 2 illustrates an electric schematic diagram of the nut milk blender device and the 102, 104, 106.

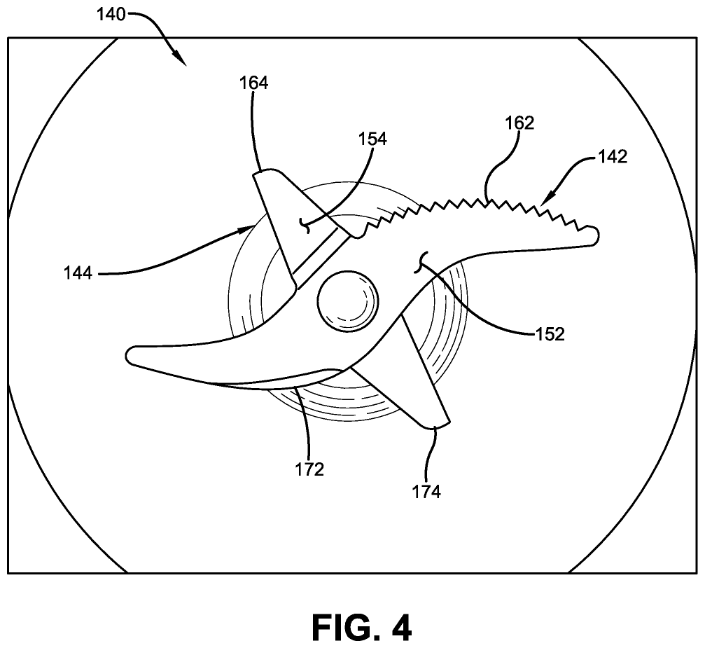

Referring to FIG. 4, an enlarged top plan view of the mixing blade arrangement in one potential embodiment is therein shown. The mixing blade arrangement 140 includes a major blade 142 and a minor blade 144. The major blade 142 includes a first area 152 and the minor blade 144 includes a second area 154. The first area 152 is greater than the second area 154. The major blade 142 includes a leading serrated edge 162 on one side of the major blade 142 and a leading knife edge 172 on another side of the major blade 142. The minor blade 144 includes an upturned tip 164 on one end of the minor blade 144 and a downturned tip 174 on an opposing end of the minor blade 144. The minor blade 144 is generally orthogonal to the major blade 142. The minor blade 144 can be mounted in a canted orientation relative to the major blade 142. The major blade 142 and minor blade 144 can comprise a material of stainless steel.

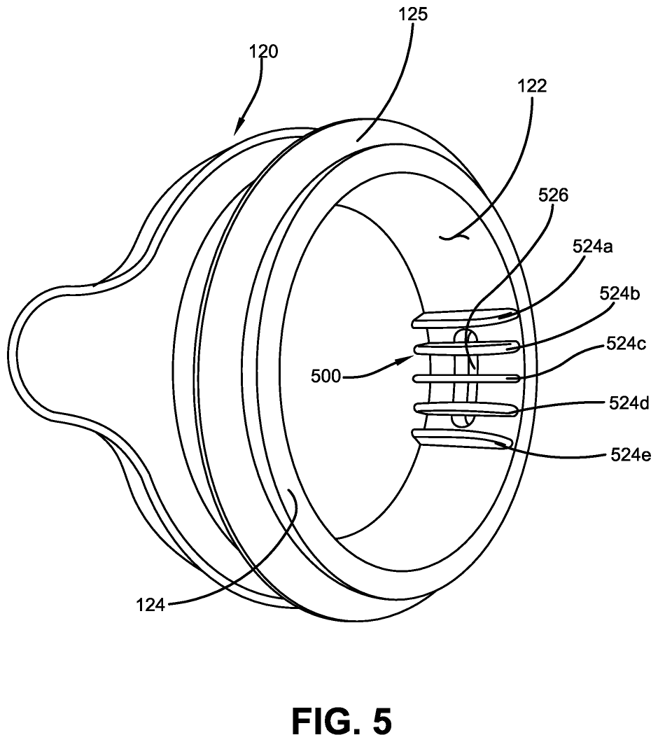

In still further embodiments, the nut blender 100 comprises a single serving quantity from about 4 ounces to about 24 ounces. Referring to FIG. 5, in one embodiment, an internal strainer/strainer 500 for filtering nut pulp from the nut milk. The strainer 500 can be situated in the interior 122 of the cap/lid 120. The strainer 500, in one exemplary arrangement, includes a plurality of fins 524a, 524b, 524c, 524d, 524e to capture nut pulp, dried fruit pieces, particulates, et. al., while the liquid milk passes through opening 526. It is to be appreciated that the filter or straining pour spout 500 is easy to clean after straining and removal of the lid 120 from the mixer body. Thus, the mixing machine 100 can comprise a filtration system that includes the internal fins 524a, 524b, 524c, 524d, 524e that strain the mixture prior to pouring from opening or straining spout 526 for minimizing the amount of pulp in the consumable product or final concoction. The lid 120 includes a seal (i.e., rubber) 125 around a neck 124 of the lid 120 for sealing the lid 120 to the mixer body.

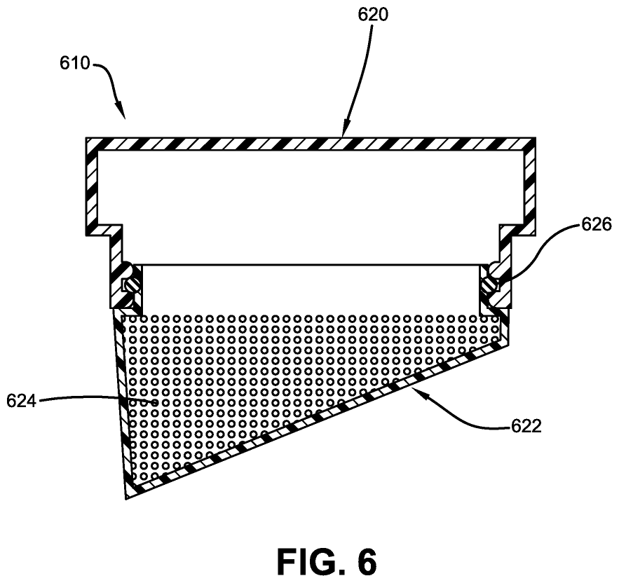

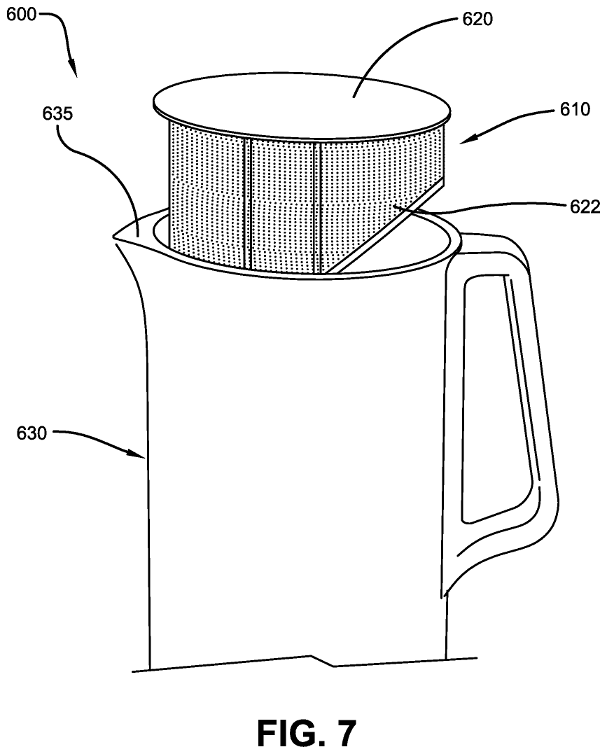

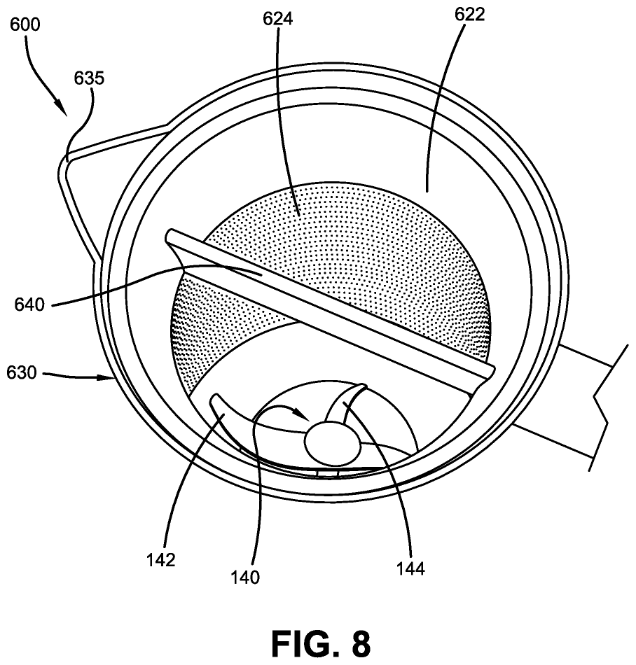

Referring to FIGS. 6-8, the mixing machine 600 can include an alternate internal unit filtration device 610 having a lid 620 and an integrated or internal filter 622 selectively attached to the lid 620. The filter 622 is selectively sealed to the lid 620 with a gasket 626. The unit filtration device 610 is selectively actuated by the user when the lid 620 and filter 622 are secured to the mixer body 630 as desired for optimal pulp removal or straining of the final product or mixture. The unit filtration and filter 622 can comprise a specific wire mesh size in order to allow the milk to pass therethrough, while capturing nut pulp, dried fruit pieces, particulates, etc. The filter 622, in one exemplary arrangement, includes a mesh size 624 from about 50 microns to about 1000 microns. In another arrangement, the mesh size 624 is from about 50 microns to about 250 microns. The filtration device 610 can work in tandem with a pour spout 635. Thus, the mixing machine 600 can comprise a filtration system 610 that includes the internal filter 622 for minimizing the amount of pulp in the consumable product or final concoction. The mixing machine 600 can include the internal unit filtration device 610 selectively actuated by the user as desired for optimal pulp removal or straining of the final product or mixture. The unit filter 622 can comprise a cross bar 640 extending across the top of the unit filter 622. The cross bar 640 enables the user to turn or rotate the unit filtration device 610 to orient the filter 622 inside the mixer body 630 (i.e., in front of the spout of the blender body) and for removal of the filter 622 from the mixer body 630.

The mixing machine 600 further can include a blender body 630 comprising a stainless steel interior and a plastic or polymer exterior. An electric power unit powers a motor for turning the blender blades 142, 144. The motor also powers a heating element for the selective heat settings to heat the ingredients placed and blended within the blender body. The electric power unit can include an electric cord and plug for connecting to an electric source or electric outlet including, for example, a 110V/60 HZ input or 220V-240V/50 HZ input power. The mixing machine further includes a cover for protecting the electronics therein.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “nut blender”, “nut milk mixer”, and “single serving nut milk blender” are interchangeable and refer to the nut milk blender of the present invention.

Notwithstanding the forgoing, the nut milk blender 100, 600 of the present invention can be of any suitable size and configuration as is known in the art without affecting the overall concept of the invention, provided that it accomplishes the above-stated objectives. One of ordinary skill in the art will appreciate that the size, configuration, and material of the nut milk blender 100, 600 as shown in the FIGS. are for illustrative purposes only, and that many other sizes and shapes of the nut milk blender 100, 600 are well within the scope of the present disclosure. Although the dimensions of the nut milk blender 100, 600 are important design parameters for user convenience, the nut milk blender 100, 600 may be of any size that ensures optimal performance during use and/or that suits the user's needs and/or preferences. In one potential embodiment, the nut milk blender 100, 600 includes a height generally from about 6 inches to about 12 inches, and a diameter from about 3 inches to about 6 inches.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A nut blender for making nut milk comprising:
a mixer including a cap, a blender body, a mixing blade configuration, and a heating element for blending nuts;
a plurality of mixer controls including a variety of preselectable settings for simultaneous blend duration and temperature setting;
said plurality of mixer controls include at least three settings, wherein a first setting includes a first blend duration and a first heat setting, a second setting includes a second blend duration and a second heat setting, and a third setting includes a third blend duration and a third heat setting; and
further wherein said second heat setting is greater than said first heat setting and said third heat setting is greater than said second heat setting.

2. The nut blender of claim 1, wherein said second blend duration is greater than said first blend duration and said third blend duration is greater than said second blend duration.

3. The nut blender of claim 2, wherein said first heat setting is zero.

4. The nut blender of claim 3, wherein said first blend duration is less than or equal to 2 minutes.

5. The nut blender of claim 4, wherein said second heat setting is less than or equal to 70 degrees C.

6. The nut blender of claim 5, wherein said second blend duration is less than or equal to 6 minutes.

7. The nut blender of claim 6, wherein said third heat setting is less than or equal to 120 degrees C.

8. The nut blender of claim 7, wherein said third blend duration is less than or equal to 20 minutes.

9. The nut blender of claim 7, wherein said third blend duration is less than or equal to 15 minutes.

10. The nut blender of claim 8, wherein said single serving is from about 6 ounces to about 20 ounces.

11. The nut blender of claim 9, further comprising a removable internal filter for filtering nut pulp from the nut milk.

12. The nut blender of claim 10, wherein said filter positioned between said cap and said blender body.

13. The nut blender of claim 11, wherein said filter includes a mesh size from about 50 microns to about 250 microns.

14. A nut blender for making nut milk comprising:
a mixer including a cap, a blender body, a mixing blade configuration, and a heating element for blending nuts;
a plurality of mixer controls including a variety of preselectable settings for simultaneous blend duration and temperature setting;
wherein said plurality of mixer controls include at least three settings, wherein a first setting includes a first blend duration and a first heat setting, a second setting includes a second blend duration and a second heat setting, and a third setting includes a third blend duration and a third heat setting;
wherein said second heat setting is greater than said first heat setting and said third heat setting is greater than said second heat setting;
a blade configuration having a major blade generally orthogonal to a minor blade;
wherein said major blade having a first area and said minor blade having a second area;
wherein said first area is greater than said second area;
wherein said major blade having a leading serrated edge on one side of said major blade and a leading knife edge on another opposing side of said major blade; and
further wherein said minor blade having an upturned tip on one end of said minor blade and a downturned tip on another opposing end of said minor blade.

15. The nut blender of claim 14, wherein said minor blade is in a canted orientation relative to said major blade.

16. The nut blender of claim 15, wherein said third blend duration is less than or equal to 15 minutes, said second blend duration is less than or equal to 6 minutes, and said first blend duration is less than or equal to 2 minutes.

17. The nut blender of claim 16, wherein said first heat setting is zero, said second heat setting is less than or equal to 70 degrees C., and said third heat setting is less than or equal to 120 degrees C.

18. The nut blender of claim 16, further comprising a removable internal filter for filtering nut pulp from the nut milk.

19. The nut blender of claim 18, wherein said internal filter positioned between said cap and said blender body.

20. A nut blender for making nut milk comprising:
a mixer including a cap, a blender body, a mixing blade configuration, and a heating element for blending nuts;
a plurality of mixer controls including a variety of preselectable settings for simultaneous blend duration and temperature setting;
wherein said plurality of mixer controls include at least three settings, wherein a first setting includes a first blend duration and a first heat setting, a second setting includes a second blend duration and a second heat setting, and a third setting includes a third blend duration and a third heat setting;
wherein said second heat setting is greater than said first heat setting and said third heat setting is greater than said second heat setting;
a filter selectively attached to said cap; and
wherein said filter having a cross bar for selective rotation of said filter for positioning said filter in front of a spout of said blender body.
